(19) United States
(12) Patent Application Publication
(10) Pub. No.: US 2006/0140264 A1
(43) Pub. Date: Jun. 29, 2006

(54) Video encoding method and corresponding encoding and decoding devices

(76) Inventors: Cecile Dufour, Paris (FR); Gwenaelle Marquant, Liffre (FR); Stephane Valente, Paris (FR)

Correspondence Address: PHILIPS INTELLECTUAL PROPERTY & STANDARDS, P.O. BOX 3001, BRIARCLIFF MANOR, NY, 10510, US

(21) Appl. No.: 10/517,920

(22) PCT Filed: Jun. 6, 2003
(86) PCT No.: PCT/IB03/02647

§ 371 Date: Dec. 14, 2004

(30) Foreign Application Priority Data
Jun. 18, 2002 (EP) 02291520.1

(51) Int. Cl. H04B 1/66; H04N 11/04; H04N 11/02; H04N 7/12

(52) U.S. Cl. 375/240.01

(57) ABSTRACT

The invention relates to an encoding method applied to a video sequence corresponding to successive scenes and generating a coded bitstream in which each data item is described by means of a bitstream syntax allowing, at the decoding side, to recognize and decode all the elements of the content of this coded bitstream. According to the invention, said syntax comprises specific syntactic means for separately describing the spatial resolution of each channel or, for each channel, the spatial resolution of each image of the input sequence. Moreover, said description may be done with respect to a reference spatial resolution, which may be either an absolute nominal spatial resolution or the spatial resolution of one of the channels. The invention also relates to the corresponding encoding device, transmittable video signal and decoding device.

### FIELD OF THE INVENTION

The present invention relates to the field of video compression and, for instance, to the video coding standards of the MPEG family MPEG-1, MPEG-2, MPEG-4) and to the recommendations of the ITU-H.26× family (H.261, H.263 and extensions, H.264). More specifically, this invention concerns an encoding method applied to a video sequence corresponding to successive scenes subdivided into successive video object planes (VOPs) and generating, for coding all the video objects of said scenes, a coded bitstream constituted of encoded video data in which each data item is described by means of a bitstream syntax allowing to recognize and decode all the elements of the content of said bitstream, said content being described in terms of separate channels.

The invention also relates to a corresponding encoding device, to a transmittable video signal consisting of a coded bitstream generated by such an encoding device, and to a device for receiving and decoding a video signal consisting of such a coded bitstream.

### BACKGROUND OF THE INVENTION

In the first video coding standards (up to MPEG-2 and H.263), the video was assumed to be rectangular and to be described in terms of a luminance channel and two chrominance channels. With MPEG-4, other channels have been introduced, the spatial resolution of which is described at the sequence level (Video Object Layer, or VOL, in MPEG-4 terminology), as defined in the MPEG-4 document w3056, “Information Technology—Coding of audio-visual objects—Part 2: Visual”, ISO/IEC/JTC1/SC29/WG11, Maui, USA, December 1999. Only one description is given for all channels. The standard defines the “video_object_layer_width” and “video_object_layer_height” syntax elements (w3056, p. 36 and p. 113), which are 13-bit unsigned integers representing the width and height of the displayable part of the luminance component in pixel units. From this values, the actual spatial resolution of the different channels is inferred as follows:
the luminance channel spatial resolution is width×height;
the shape channel spatial resolution is also width×height;
the chrominance channels spatial resolution is (width/2)×(height/2).

MPEG-4 also defines the so-called reduced resolution VOP tool. When this tool is used, the size of the macroblock used for motion compensation decoding is 32×32 pixels and the size of the blocks is 16×16 pixels. It corresponds to the encoding of quarter resolution pictures (decimated by a factor of 2 vertically and horizontally) at the encoding side. The decoded pictures are then upsampled to the normal resolution (width×height) at the decoding side. The standard has also additional syntax elements. A one bit-flag “reduced_resolution_vop_enable”, found at the VOL level (w3056, p. 38 and p. 118), indicates that the “Dynamic Resolution Conversion” (DRC) tool is enabled when set to ‘1’. In such a case, the single bit flag “vop_reduced_resolution” has to be retrieved from every VOP header (w3056, p. 41, p. 47 and p. 121). It signals whether the VOP is encoded at spatially reduced resolution or not. When this flag is set to ‘1’, the VOP is encoded spatially reduced resolution and referred as Reduced Resolution VOP. When this flag is set to “0” or this flag is not present, the VOP is encoded in normal spatial resolution and shall be decoded by the normal decoding process. From these remarks, it can be seen that the spatial resolution of the picture is described at the VOP level, and unfortunately, all channels have to share the same description.

### SUMMARY OF THE INVENTION

It is therefore an object of the invention to propose a video coding method allowing to describe a video sequence with channels that have different resolutions.

To this end, the invention relates to a method such as defined in the introductory part of the description and which is moreover characterized in that said syntax comprises specific syntactic means for separately describing the spatial resolution of each channel.

The proposed solution, allowing to describe a video sequence with separate channels that have different characteristics, leads to a greater flexibility in digital video coding systems, such as the future H.264 recommendation.

In a more flexible solution, said syntactic means may even comprise, for each channel, specific syntactic elements for separately describing the spatial resolution of each image of the sequence (this solution may be optional), and this description may be given, for the current image of the input sequence, with respect to the spatial resolution of the previous image in the same channel.

For each channel and for each current image, said spatial resolution may moreover be described with respect to a reference (or nominal) spatial resolution, which is for instance a predetermined spatial resolution indicated at the beginning of the bitstream, or the spatial resolution of one of the channels. The spatial resolution will be preferably described by means of a division or a multiplication of said reference spatial resolution.

The invention also relates to a device for encoding a video sequence corresponding to successive scenes subdivided into successive video object planes (VOPs), said device comprising means for structuring each scene of said sequence as a composition of video objects (VOs), means for coding the shape, the motion and the texture of each of said VOs, and means for multiplexing the coded elementary streams thus obtained into a single coded bitstream constituted of encoded video data in which each data item is described by means of a bitstream syntax allowing to recognize and decode all the elements of the content of said bitstream, said content being described in terms of separate channels, said device being further characterized in that said multiplexing means comprise means for introducing into said single bitstream a specific information for separately describing the spatial resolution of each of said separate channels.

The invention also relates to a transmittable video signal consisting of a coded bitstream generated by an encoding method applied to a sequence corresponding to successive scenes subdivided into successive video object planes (VOPs), said coded bitstream, generated for coding all the video objects of said scenes, being constituted of encoded video data in which each data item is described by means of a bitstream syntax allowing to recognize and decode all the elements of the content of said bitstream, said content being described in terms of separate channels, said signal being further characterized in that it includes a specific information for separately describing the spatial resolution of each of said separate channels.

The invention finally relates to a device for receiving and decoding a video signal consisting of a coded bitstream generated by an encoding method applied to a video sequence corresponding to successive scenes subdivided into successive video object planes (VOPs), said coded bitstream, generated for coding all the video objects of said scenes, being constituted of encoded video data in which each data item is described by means of a bitstream syntax allowing to recognize and decode all the elements of the content of said bitstream, said content being described in terms of separate channels, and moreover comprising a specific information for separately describing the spatial resolution of each of said separate channels, said decoding device being further characterized in that it includes means for reading in the received coded bitstream the specific spatial resolution of each of said separate channels.

### DETAILED DESCRIPTION OF TH INVENTION

As said above, it is not possible, at that moment, to describe a video sequence with channels that have different resolutions. For instance, instead of having the classical quarter spatial resolution for the chrominance channels (decimated by a factor 2 in each direction), due to bitrate constraints, one could imagine to have a 9th resolution chrominance channels (decimated by a factor 3 in each direction). The solutions proposed here provide some syntax elements to support the lack of flexibility of current standards (to offer also more flexibility for future standards, the solution is extended to different channels, other than the luminance and chrominance ones, and proposes the reduced resolution channel tool).

In the following, it is assumed that the presence of channels is described by several syntax elements at the sequence level (VOL in MPEG-4 terminology), for instance as:

Channels Presence Description:

| | |
|---|---|
| Video_object_layer_lum | 1 bit |
| Video_object_layer_chrom | 1 bit (0 for black and white) |
| Video_object_layer_shape | 1 bit (0 for rectangular) |
| number_of_additional_channels | 4 bits |
| video_object_layer_additional_channel[0] | 1 bit |
| video_object_layer_additional_channel[1] | 1 bit |
| video_object_layer_additional_channel[i] | 1 bit |
| . . . | |

These syntax elements should be read as follows:
if “Video_object_layer_lum” is 1, it means that the bitstream contains syntax elements for a luminance channel;
if “Video_object_layer_chrom” is 1, the bitstream contains syntax elements for the chrominance channels, else the sequence is assumed to be black and white;
if “Video_object_layer_shape” is 1, the bitstream contains syntax elements to describe a non-rectangular shape for the picture, else it is assumed to be rectangular;
if “number_of additional_channels” is not zero, the bitstream contains syntax elements describing additional channels, which presence or not is described by video_object_layer_additional_channel[i] syntax element.

The following flags and syntax elements (in italic) are proposed to describe the spatial resolution and the availability of the reduced resolution tool of every channel. The basic idea is to start from a nominal resolution (the maximum resolution of all channels) and to express the spatial resolution of every channel in terms of ratios of this nominal size.

At sequence high level description (equivalent to VOL MPEG-4 level), the following syntax elements are proposed:

TABLE 1

| | | |
|---|---|---|
| Element | Type | Semantic |

typical for Claim 1

| | | |
|---|---|---|
| Vol_horiz_sampling_elements_lum | Unsigned | Width of luminance channel in |
| | integer | pixels |
| Vol_vert_sampling_elements_lum | Unsigned | Height of luminance channel in |
| | integer | pixels |
| Vol_horiz_sampling_elements_channels[i] | Unsigned | Width of the i^{th} additional channel |
| | integer | |
| Vol_vert_sampling_elements_channels[i] | Unsigned | Height of the i^{th} additional channel |
| | integer | |

typical for Claim 2

| | | |
|---|---|---|
| Vop_horiz_reduced_resolution_lum | 1 bit | Use the horizontal reduced |
| | | resolution tool on the luminance |
| | | channel |
| Vop_vert_reduced_resolution_lum | 1 bit | Use the vertical reduced resolution |
| | | tool on the luminance channel |
| Vop_horiz_reduced_resolution_channels[I] | 1 bit | Use the horizontal reduced |
| | | resolution tool on the i^{th} additional |
| | | channel |
| Vop_vert_reduced_resolution_channels[i] | 1 bit | Use the vertical reduced resolution |
| | | tool on the i^{th} additional channel |

typical for Claim 3

| | | |
|---|---|---|
| Vol_horiz_reduced_resolution_lum_enable | 1 bit | Enable the horizontal reduced |
| | | resolution tool on the luminance |
| | | channel |
| Vol_vert_reduced_resolution_lum_enable | 1 bit | Enable the vertical reduced |
| | | resolution tool on the luminance |
| | | channel |
| Vol_horiz_reduced_resolution_channels_enable[i] | 1 bit | Enable the horizontal reduced |
| | | resolution tool on the i^{th} additional |
| | | channel |
| Vol_vert_reduced_resolution_channels_enable[i] | 1 bit | Enable the vertical reduced |
| | | resolution tool on the i^{th} additional |
| | | channel |

typical for Claim 6

| | | |
|---|---|---|
| Vol_horiz_sampling_elements | 13 bits | Horizontal nominal size (pixels) |
| Vol_vert_sampling_elements | 13 bits | Vertical nominal size (pixels) |

typical for Claim 8

| | | |
|---|---|---|
| Vol_horiz_sampling_resolution_lum_ratio | 2 bits | Ratio between horizontal nominal |
| | | size and luminance horizontal size |
| Vol_vert_sampling_resolution_lum_ratio | 2 bits | Ratio between vertical nominal |
| | | size and luminance vertical size |
| Vol_horiz_sampling_resolution_channels_ratio[i] | 2 bits | Ration between horizontal |
| | | nominal size and i^{th} additional |
| | | channel horizontal size |
| Vol_vert_sampling_resolution_channels_ratio[I] | 2 bits | Ration between vertical nominal |
| | | size and i^{th} additional channel |
| | | vertical size |

The invention is obviously not limited to the encoding method thus defined. It also relates to a device for encoding a video sequence corresponding to successive scenes subdivided into successive video object planes (VOPs), said device comprising means for structuring each scene of said sequence as a composition of video objects (VOs), means for coding the shape, the motion and the texture of each of said VOs, and means for multiplexing the coded elementary streams thus obtained into a single coded bitstream constituted of encoded video data in which each data item is described by means of a bitstream syntax allowing to recognize and decode all the elements of the content of said bitstream, said content being described in terms of separate channels, said device being further characterized in that said multiplexing means comprise means for introducing into said single bitstream a specific information for separately describing the spatial resolution of each of said separate channels.

The invention also relates to a transmittable video signal consisting of a coded bitstream generated by an encoding method applied to a sequence corresponding to successive scenes subdivided into successive video object planes (VOPs), said coded bitstream, generated for coding all the video objects of said scenes, being constituted of encoded video data in which each data item is described by means of a bitstream syntax allowing to recognize and decode all the elements of the content of said bitstream, said content being described in terms of separate channels, said signal being further characterized in that it includes a specific information for separately describing the spatial resolution of each of said separate channels.

The invention finally relates to a device for receiving and decoding a video signal consisting of a coded bitstream generated by an encoding method applied to a video sequence corresponding to successive scenes subdivided into successive video object planes (VOPs), said coded bitstream, generated for coding all the video objects of said scenes, being constituted of encoded video data in which each data item is described by means of a bitstream syntax allowing to recognize and decode all the elements of the content of said bitstream, said content being described in terms of separate channels, and moreover comprising a specific information for separately describing the spatial resolution of each of said separate channels, said decoding device being further characterized in that it includes means for reading in the received coded bitstream the specific spatial resolution of each of said separate channels.

The video coding method described above may be implemented in a coding device based on the specifications of the MPEG-4 standard. In the MPEG-4 video framework, each scene, which may consist of one or several video objects (and possibly their enhancement layers), is structured as a composition of these objects, called Video Objects (VOs) and coded using separate elementary bitstreams. The input video information is therefore first split into Video Objects by means of a segmentation circuit, and these VOs are sent to a basic coding structure that involves shape coding, motion coding and texture coding. Each VO is, in view of these coding steps, divided into macroblocks, that consist for example in four luminance blocks and two chrominance blocks for the format 4:2:0 for example, and are encoded one by one. According to the invention, the multiplexed bitstream including the coded signals resulting from said coding steps will include the syntactic element indicating at a high description level, for each channel described in the coded bitstream, the presence, or not, of an encoded residual signal. Reciprocally, according to a corresponding decoding method, this syntactic element, transmitted to the decoding side, is read by appropriate means in a video decoder receiving the coded bitstream that includes said element and carrying out said decoding method. The decoder, which is able to recognize and decode all the segments of the content of the coded bitstream, reads said additional syntactic element and knows that no encoded residual signal is then present. Both in the coding and decoding device, a controller may be provided for managing the steps of the coding or decoding operations.

The foregoing description of the preferred embodiments of the invention has been presented for purposes of illustration and description. It is not intended to be exhaustive or to limit the invention to the precise forms disclosed, and obviously modifications and variations, apparent to a person skilled in the art and intended to be included within the scope of this invention, are possible in light of the above teachings.

It may for example be understood that the coding and decoding devices described herein can be implemented in hardware, software, or a combination of hardware and software, without excluding that a single item of hardware or software can carry out several functions or that an assembly of items of hardware and software or both carry out a single function. The described methods and devices may be implemented by any type of computer system or other adapted apparatus. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized.

The present invention can also be embedded in a computer program product, which comprises all the features enabling the implementation of the methods and functions described herein and—when loaded in a computer system—is able to carry out these methods and functions. Computer program, software program, program, program product, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

1. An encoding method applied to an input video sequence corresponding to successive scenes subdivided into successive video object planes (VOPs) and generating, for coding all the video objects of said scenes, a coded bitstream constituted of encoded video data in which each data item is described by means of a bitstream syntax allowing to recognize and decode all the elements of the content of said bitstream, said content being described in terms of separate channels, said method being further characterized in that said syntax comprises specific syntactic means for separately describing the spatial resolution of each channel.

2. A method according to claim 1, characterized in that said syntactic means comprise, for each channel, specific syntactic elements for separately describing the spatial resolution of each image of the input sequence.

3. A method according to claim 2, characterized in that said separate description of the spatial resolution of each image of the input sequence is optional.

4. A method according to claim 2, characterized in that, for each channel, said syntactic means comprise syntactic elements for describing the spatial resolution of the current image of the input sequence with respect to the spatial resolution of the previous image in the same channel.

5. A method according to claim 2, characterized in that, for each channel and for each image, the spatial resolution is described with respect to a reference spatial resolution.

6. A method according to claim 5, characterized in that said reference spatial resolution is a predetermined spatial resolution indicated at the beginning of the bitstream.

7. A method according to claim 5, characterized in that said reference spatial resolution is the spatial resolution of one of the channels.

8. A method according to claim 5, characterized in that the spatial resolution is described by means of a division of said predetermined reference spatial resolution.

9. A method according to claim 5, characterized in that the spatial resolution is described by means of a multiplication of said predetermined reference spatial resolution.

10. A device for encoding a video sequence corresponding to successive scenes subdivided into successive video object planes (VOPs), said device comprising means for structuring each scene of said sequence as a composition of video objects (VOs), means for coding the shape, the motion and the texture of each of said VOs, and means for multiplexing the coded elementary streams thus obtained into a single coded bitstream constituted of encoded video data in which each data item is described by means of a bitstream syntax allowing to recognize and decode all the elements of the content of said bitstream, said content being described in terms of separate channels, said device being further characterized in that said multiplexing means comprise means for introducing into said single bitstream a specific information for separately describing the spatial resolution of each of said separate channels.

11. A transmittable video signal consisting of a coded bitstream generated by an encoding method applied to a sequence corresponding to successive scenes subdivided into successive video object planes (VOPs), said coded bitstream, generated for coding all the video objects of said scenes, being constituted of encoded video data in which each data item is described by means of a bitstream syntax allowing to recognize and decode all the elements of the content of said bitstream, said content being described in terms of separate channels, said signal being further characterized in that it includes a specific information for separately describing the spatial resolution of each of said separate channels.

12. A device for receiving and decoding a video signal consisting of a coded bitstream generated by an encoding method applied to a video sequence corresponding to successive scenes subdivided into successive video object planes (VOPs), said coded bitstream, generated for coding all the video objects of said scenes, being constituted of encoded video data in which each data item is described by means of a bitstream syntax allowing to recognize and decode all the elements of the content of said bitstream, said content being described in terms of separate channels, and moreover comprising a specific information for separately describing the spatial resolution of each of said separate channels, said decoding device being further characterized in that it includes means for reading in the received coded bitstream the specific spatial resolution of each of said separate channels.
